(19) United States
(12) Patent Application Publication
(10) Pub. No.: US 2013/0193794 A1
(43) Pub. Date: Aug. 1, 2013

(54) SPINDLE MOTOR

(71) Applicant: SAMSUNG ELECTRO-MECHANICS CO., LTD., Gyunggi-do (KR)

(72) Inventor: Dong Woo Lee, Gyunggi-do (KR)

(73) Assignee: SAMSUNG ELECTRO-MECHANICS CO., LTD., Gyunggi-do (KR)

(21) Appl. No.: 13/662,335

(22) Filed: Oct. 26, 2012

(30) Foreign Application Priority Data
Oct. 27, 2011 (KR) 10-2011-0110726

(51) Int. Cl. H02K 1/27

(52) U.S. Cl. CPC H02K 1/2786
USPC 310/156.04

(57) ABSTRACT

Disclosed herein is a spindle motor in which the center of a main magnet configuring a rotor is positioned at a position higher than that of the center of a core configuring an armature, such that magnetic force generated in the main magnet acts downwardly, thereby easily preventing the floating of the rotor.

### CROSS REFERENCE TO RELATED APPLICATION

This application claims the benefit of Korean Patent Application No. 10-2011-0110726, filed on Oct. 27, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

In a spindle motor, a shaft rotates while maintaining a predetermined contact section between a bearing and the shaft, such that rotational characteristics may be easily maintained. Therefore, the spindle motor has been widely used as a driving unit of a recording medium requiring high speed rotation, such as a hard disk drive (HDD), an optical disk drive (ODD), or the like.

The spindle motor generally includes an armature, a rotor including a main magnet generating electromagnetic force between the main magnet and the armature, and a stator rotatably supporting the rotor, and rotates the rotator by the electromagnetic force generated between the armature and the main magnet.

Meanwhile, the spindle motor includes a pulling magnet in order to prevent the rotor from being floated due to rotational force generated at the time of driving thereof. That is, as shown in FIG. 1 of Patent Document 1, the pulling magnet is installed on a lower portion of a rotor case configuring the rotor or an upper portion of a core configuring the armature to prevent an error of the recording medium due to vertical vibration.

Therefore, the spindle motor according to the prior art including Patent Document 1 may prevent the floating of the rotor due to the rotational force generated at the time of the driving of the spindle motor using the pulling magnet

However, in the case in which the spindle motor is designed to include the pulling magnet, it is difficult to make the spindle motor thin. Further, in the case in which a cost of a raw material increases, since the increase in the cost of the raw material should be reflected in a cost of the spindle motor, it is difficult to reduce the cost of the spindle motor.

Therefore, a technology of removing the pulling magnet disclosed in Patent Document 1 or reducing a size of the pulling magnet even though the pulling magnet is used has been demanded.

### PRIOR ART DOCUMENT

### Patent Document

(Patent Document 1) KR2009-0058163 A

### SUMMARY OF THE INVENTION

The present invention has been made in an effort to provide a spindle motor capable of easily preventing floating of a rotor by adjusting a position of a main magnet.

According to a preferred embodiment of the present invention, there is provided a spindle motor including: an armature including a core; a rotor including a main magnet disposed to face the core to generate electromagnetic force; and a stator rotatably supporting the rotor, wherein the center of the main magnet is positioned at a position higher than that of the center of the core by 0.1 to 0.4 mm.

The rotor may include: a shaft; a rotor case fixed to the shaft and having the main magnet provided at an inner portion thereof; and a clamp installed at an upper portion of the rotor case to elastically support a recording medium.

The stator may include: a bearing rotatably supporting the shaft; a bearing holder having the bearing inserted thereinto; a plate having the bearing holder installed thereon and a substrate.

The stator may further include a stopper and a thrust provided on the bearing holder.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view showing a spindle motor according to a preferred embodiment of the present invention;

FIG. 2 is an enlarged cross-sectional view showing a main magnet and a core shown in FIG. 1; and

FIG. 3 is a partially enlarged cross-sectional view of a direction in which magnetic force of the main magnet shown in FIG. 1 acts.

FIG. 4 is a graph indicates experimental data of a spindle motor in which the center of the main magnet is positioned at a position lower than that of the center of the core, shows that pulling force required in the spindle motor decreases.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

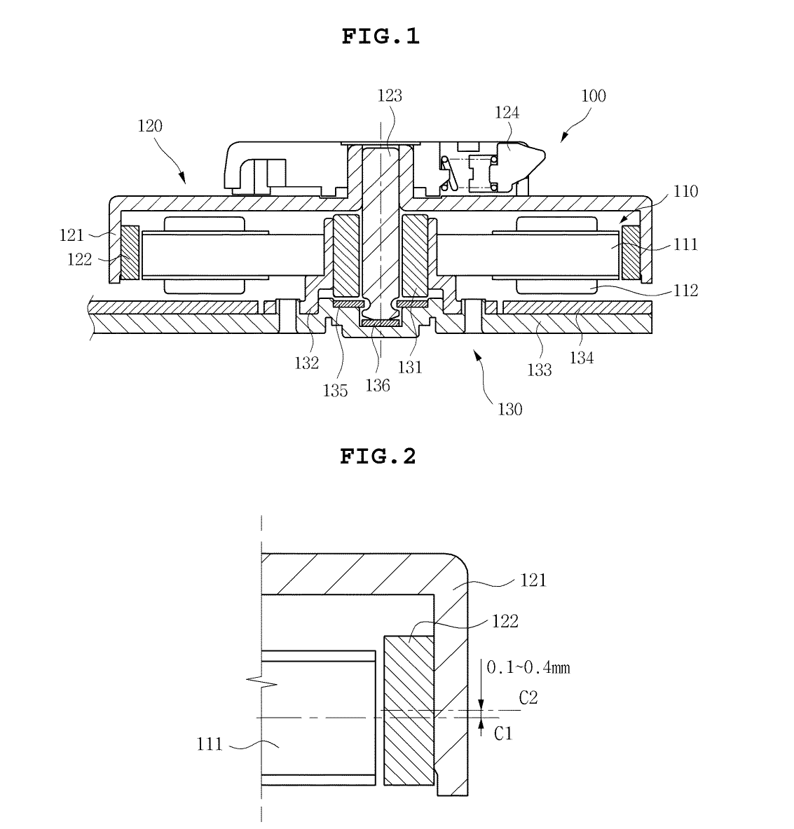

A spindle motor 100 according to a preferred embodiment of the present invention includes an armature 110, a rotor 120, and a stator 130, as shown in FIG. 1.

The armature 110 includes a core 111, wherein the core 111 has a coil 112 wound therearound. Therefore, the armature 110 generates electromagnetic force between the armature 110 a main magnet to rotate the rotor 120.

The rotor 120 includes a rotor case 121, the main magnet 122, and a shaft 123. In addition, the rotor 120 includes a clamp 124 installed at an upper portion of the rotor case 121 to fix a recording medium, that is, a magnetic disk or an optical disk.

The rotor 120 is rotatably installed at the stator 130 through the shaft 123. To this end, the stator 130 includes a bearing 131 rotatably supporting the shaft 123 and a bearing holder 132 having a bearing 131 installed therein, wherein the bearing holder 132 has the armature 110 fixed to an outer portion thereof.

In addition, the stator 130 includes a base 133 on which the bearing holder 132 is installed and a substrate 134 installed on the base 133. Therefore, external power is supplied to the armature 110 through the substrate 134.

Therefore, the shaft 123 is vertically installed in the bearing 131 and the external power is supplied to the armature 110 through the substrate 134, such that the rotor rotates by the electromagnetic force generated by the main magnet 122 and the armature 110. Therefore, the recording medium elastically mounted on the clamp 124 rotates.

Here, an inner portion of the bearing holder 132, that is, a lower portion of the bearing 131 is provided with a stopper 135 and a thrust 136, wherein the stopper 135 prevents the shaft 123 from being floated and the thrust supports the shaft 123 so that the shaft 123 easily rotates.

Meanwhile, in the spindle motor 100 according to the preferred embodiment of the present invention, as shown in FIG. 2, the magnetic center, that is, the center of the main magnet 122 is positioned at a position higher than that of the center C1 of the core 111. More specifically, the main magnet 122 is provided in the rotor case 121 so that the center thereof is positioned at a position higher than that of the center C1 of the core 111 by 1.0 mm to 0.4 mm.

Here, the definition of the numerical value is to easily generate pulling force N required in the spindle motor 100 to replace or complement a general pulling magnet.

That is, in the case in which a distance between the center C2 of the main magnet 122 and the center C1 of the core 111 is less than 0.1 mm or exceeds 0.4 mm, the pulling force N required in the spindle motor 100 does not increase, but rather decreases. Experimental data thereof are represented by the following Table 1.

TABLE 1

| Center of | [+] Direction: Direction Toward | | | | | | |
|---|---|---|---|---|---|---|---|
| Main | Position Higher Than That of Core | | | | | | |
| Magnet (mm) | −0.2 | −0.1 | 0 | 0.1 | 0.2 | 0.3 | 0.4 |
| Pulling Force | 0.4 | 0.2 | 0 | −0.2 | −0.4 | −0.6 | −0.7 |

| | |
|---|---|
| (N) | [−] Direction: Direction Toward Increase |
| | of Pulling Force |

It could be appreciated that pulling force of 0.2 to 2N required in the spindle motor 100 is generated only in the case in which the center C2 of the main magnet 122 moves to a position higher than that of the center C1 of the core 111 by 0.1 to 0.4 mm.

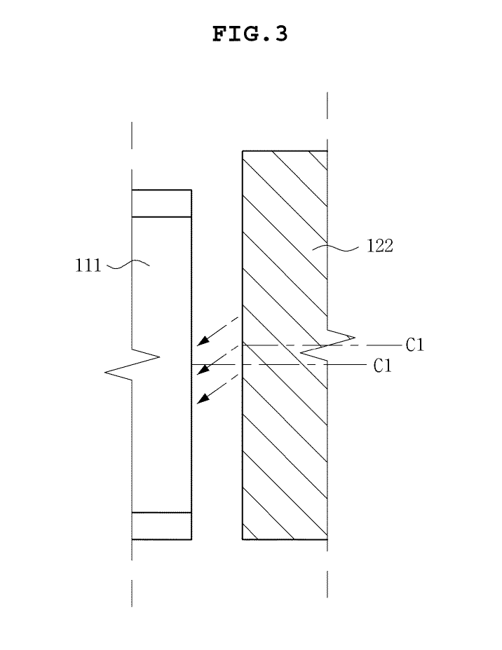

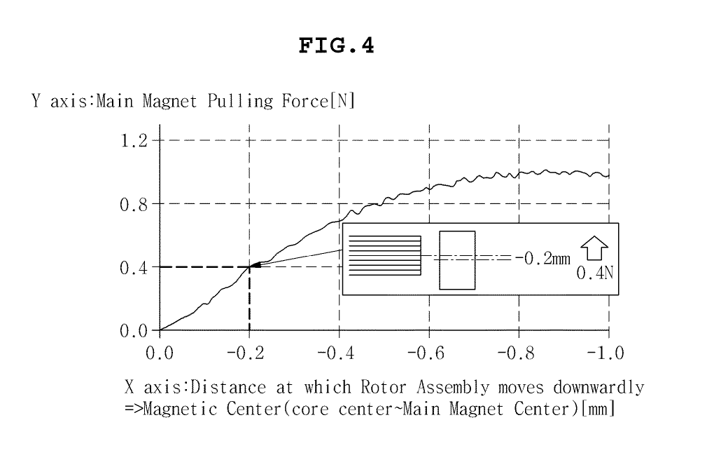

Therefore, as seen from Table 1 and FIG. 4, the rotor case 121 is disposed so that the center C2 of the main magnet 122 is positioned at a position higher than that of the center C1 of the core 111, such that magnetic force of the main magnet 122 acts downwardly as shown in FIG. 3, thereby making it possible to easily prevent the floating of the rotor 120, which is a role of a general pulling magnet.

As set forth above, according to the preferred embodiment of the present invention, the center of the main magnet is positioned at a position higher than that of the center of the core by 0.1 to 0.4 mm to generate the pulling force required in the spindle motor, thereby making it possible to easily prevent the floating of the rotor, instead of the pulling magnet.

Therefore, the spindle motor is designed without the pulling magnet, thereby making it possible to reduce the number of components and a cost. In addition, even though the pulling magnet is used, a size of the pulling magnet is significantly reduced, thereby making it possible to reduce a cost.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor comprising:
an armature including a core;
a rotor including a main magnet disposed to face the core to generate electromagnetic force; and
a stator rotatably supporting the rotor,
wherein the center of the main magnet is positioned at a position higher than that of the center of the core by 0.1 mm to 0.4 mm.

2. The spindle motor as set forth in claim 1, wherein the rotor includes:
a shaft;
a rotor case fixed to the shaft and having the main magnet provided at an inner portion thereof; and
a clamp installed at an upper portion of the rotor case to elastically support a recording medium.

3. The spindle motor as set forth in claim 2, wherein the stator includes:
a bearing rotatably supporting the shaft;
a bearing holder having the bearing inserted thereinto;
a plate having the bearing holder installed thereon and a substrate.

4. The spindle motor as set forth in claim 3, wherein the stator further includes a stopper and a thrust provided on the bearing holder.
